(19) United States
(12) Patent Application Publication
(10) Pub. No.: US 2014/0058783 A1
(43) Pub. Date: Feb. 27, 2014

(54) SYSTEM AND METHOD FOR OPTIMIZING CATASTROPHE BASED RESOURCES

(71) Applicants: Nirav N. Modi, East Hartford, CT (US); Michael J. Blasko, Portland, CT (US)

(72) Inventors: Nirav N. Modi, East Hartford, CT (US); Michael J. Blasko, Portland, CT (US)

(73) Assignee: Hartford Fire Insurance Company, Hartford, CT (US)

(21) Appl. No.: 13/591,996

(22) Filed: Aug. 22, 2012

(51) Int. Cl. G06Q 10/06

(52) U.S. Cl. 705/7.25

(57) ABSTRACT

Provided are systems and methods for determining the number of persons necessary to process a projected number of insurance claims for a forecasted catastrophic event, based at least on the projected number of insurance claims, an insurance claim-reporting pattern corresponding to the type of forecasted catastrophic event, a series of work phases for processing the projected insurance claims, work distribution patterns for the work phases, estimated times for completing the work phases, and claim resolution rates for the work phases.

### FIELD OF INVENTION

The present invention relates generally to handling of catastrophe insurance claims, and more particularly, to the optimization of catastrophe-based resources for handling a projected number of catastrophe insurance claims for a forecasted catastrophic event.

### BACKGROUND

Catastrophe insurance protects businesses and residences against catastrophic events such as earthquakes, floods, tornadoes, hurricanes, blizzards and hailstorms. Catastrophic events are low-probability, but result in a very large number of insurance claims being filed in a short period of time. Thus, although catastrophic events are infrequent, they are resource-intensive events to insurance companies. As a result it is difficult for catastrophe insurance issuers to effectively manage catastrophe based resources to handle the sudden and large volume of insurance claims resulting from a catastrophic event.

In order to timely handle sudden and large volume spikes in insurance claims resulting from catastrophic events, catastrophe insurance issuers need to maintain adequate staffing levels during a catastrophic event. Accordingly, it would be preferable to be able to predict the staffing level necessary to handle a projected number of insurance claims expected from one or more catastrophic event and to determine whether an existing staffing level is adequate or adjustment to the existing staffing level is necessary.

### SUMMARY

In accordance with one aspect of the invention, provided is a computer system for determining the number of persons needed to process a projected number of insurance claims expected from a forecasted catastrophic event. The system comprises a data storage device and at least one processor connected to the data storage device. The data storage device also comprising a database and a resource-modeling program for determining the number of persons needed to process the projected number of insurance claims expected from the forecasted catastrophic event. The database storing one or more insurance claim-reporting patterns and time estimates for processing insurance claims for various types of catastrophic events. The processor executes the resource-modeling program stored in data storage device to determine the number of persons needed to process the projected number of insurance claims. The resource-modeling program receives information regarding the projected number of insurance claims expected from the forecasted catastrophic event and receives a selection of a reporting pattern corresponding to the type of forecasted catastrophic event from the one or more insurance claim-reporting patterns stored in the database. The resource-modeling program determines the number of persons needed to process the projected number of insurance claims, based on at least the projected number of insurance claims, a selected reporting pattern, and one of the time estimates corresponding to the forecasted catastrophic event.

In accordance with another aspect of the invention, provided is a computerized method for determining a number of persons needed to process a projected number of insurance claims from a forecasted catastrophic event. The method is preferably executed by a resource-modeling program executing on a computer processor. In accordance with one embodiment, the method may include receiving information regarding the projected number of insurance claims expected from the forecasted catastrophic event. The method may also include receiving a selection of a reporting pattern corresponding to the type of forecasted catastrophic event from the one or more reporting patterns stored in the database. The method may also include determining a time estimate for processing an insurance claim for the forecasted catastrophic event. The method may further include determining the number of persons per day needed to process the projected number of insurance claims, based on at least the projected number of insurance claims, the selected reporting pattern, and the determined time estimate for processing an insurance claim for the forecasted catastrophic event.

In accordance with yet another aspect of the invention, provided is a non-transitory, tangible computer-readable medium storing instructions adapted to be executed by a computer processor to perform the above-described method for determining a number of persons needed to process a projected number of insurance claims from a forecasted catastrophic event.

### BRIEF DESCRIPTION OF THE FIGURES

The foregoing summary, as well as the following detailed description of the preferred embodiments, is better understood when read in conjunction with the appended drawings. For the purpose of illustrating the invention, there is shown in the drawings embodiments that are presently preferred, it being understood, however, that the invention is not limited to the specific embodiments disclosed. In the drawings:

FIG. 1 is a block diagram of an insurance computer network, according to an illustrative embodiment of the invention

FIG. 2 is a block diagram of a computer system in the insurance computer network of FIG. 1, according to an illustrative embodiment of the invention

FIG. 3 shows an exemplary reporting pattern for a large hurricane catastrophic event, according to an illustrative embodiment of the invention;

FIG. 4 shows an exemplary reporting pattern for a hailstorm catastrophic event, according to an illustrative embodiment of the invention;

FIG. 5 shows an exemplary breakdown of percentages of insurance claims handled by different types of adjusters for a large hurricane and a hailstorm, according to an illustrative embodiment of the invention;

FIG. 6 is flow chart depicting a process for determining the appropriate staffing level for handling a projected number of claims expected from a catastrophic event, according to an illustrative embodiment of the invention;

FIG. 7 is an exemplary calculation that is illustrative of part of the process depicted in FIG. 6, according to an illustrative embodiment of the invention;

FIG. 8 is another exemplary calculation that is illustrative of part of the process depicted in FIG. 6, according to an illustrative embodiment of the invention;

FIG. 9 is another exemplary calculation that is illustrative of part of the process depicted in FIG. 6, according to an illustrative embodiment of the invention;

FIG. 10 is another exemplary calculation that is illustrative of part of the process depicted in FIG. 6, according to an illustrative embodiment of the invention;

FIG. 11 is another exemplary calculation that is illustrative of part of the process depicted in FIG. 6, according to an illustrative embodiment of the invention;

FIG. 12 shows an exemplary result of the process depicted in FIG. 6, according to an illustrative embodiment of the invention; and

FIG. 13 shows a graphical illustration of the result shown in FIG. 12, according to an illustrative embodiment of the invention.

### DETAILED DESCRIPTION

Before the various embodiments are described in further detail, it is to be understood that the invention is not limited to the particular embodiments described. It will be understood by one of ordinary skill in the art that the systems and methods described herein may be adapted and modified as is appropriate for the application being addressed and that the systems and methods described herein may be employed in other suitable applications, and that such other additions and modifications will not depart from the scope thereof. It is also to be understood that the terminology used is for the purpose of describing particular embodiments only, and is not intended to limit the scope of the claims of the present application.

In the drawings, like reference numerals refer to like features of the systems and methods of the present application. Accordingly, although certain descriptions may refer only to certain Figures and reference numerals, it should be understood that such descriptions might be equally applicable to like reference numerals in other Figures.

The present application is directed to systems and methods for determining the number of persons necessary to process a projected number of insurance claims for a forecasted catastrophic event based on a number of different factors. These factors may include: a projected number of insurance claims for a forecasted catastrophic event, an insurance claim-reporting pattern corresponding to the type of forecasted catastrophic event, work distribution patterns for a series of work phases for processing the projected number of insurance claims, time estimates for completing each of the work phases, and claim resolution rates for each of the work phases. The relationship of these factors to the determination of the number of persons necessary to process a projected number of insurance claims for a forecasted catastrophic event is described in greater detail below in connection with the description of a resource-modeling program executed by a computer processor in an insurance company computer system.

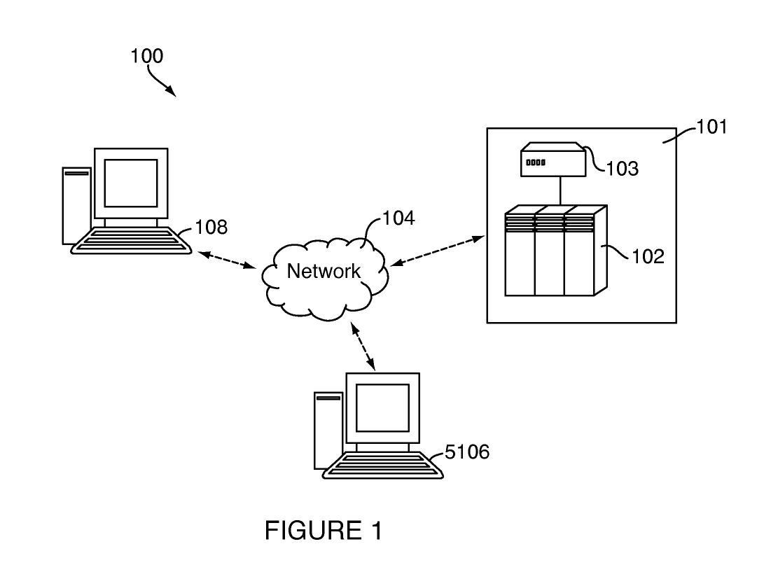

FIG. 1 is a block diagram of an insurance computer network 100, according to an illustrative embodiment of the invention. The insurance computer network 100 includes an insurance company 101 with an insurance company computer system 102 and a web server 103. The insurance company 101, its computer system 102, and/or its web server 103 are linked, via network 104, to one or more remote computer systems 106, 108. Web server 103 may include one or more applications or server-side application code for communicating with remote computer systems 106, 108. Web server 103 delivers web pages, markup documents, spreadsheets and/or electronic messages generated by the server side application code to remote computer systems 106, 108. Remote computer systems 106, 108 may be any suitable devices that are capable of communication with the insurance company computer system 102 via a web interface, such as a Personal Computer (PC), a portable computing device such as a Personal Digital Assistant (PDA), tablet computer or smart-phone type device, or any other appropriate storage and/or communication device.

Web server 103 may also include a real time, bidirectional, and reliable messaging application to transmit messages to one or more remote computer systems 106, 108. In the present invention, messages may include facsimiles and/or electronic mail message such as electronic mail messages based on one or more of the messaging protocols including IMAP, POP3, MIME and SMTP for sending a notification to remote computer systems 106, 108. Remote computer systems 106, 108 may comprise any suitable devices for receiving notifications (e.g., email, facsimile, etc.) from the insurance company computer system 102, such as handheld electronic devices, telephones, facsimile machines, email servers, and/or other transmission device.

The network 104 may be may be one or a combination of a Local Area Network (LAN), a Metropolitan Area Network (MAN), a Wide Area Network (WAN), a proprietary network, a Public Switched Telephone Network (PSTN), a Wireless Application Protocol (WAP) network, a BLUETOOTH® network, a wireless LAN network, and/or an Internet Protocol (IP) network such as the Internet, an intranet, or an extranet. Note that any devices described herein may communicate via one or more such communication networks. In some embodiments, different networks are used to link different components of the insurance computer network 100 together. For example, the systems associated with the insurance company 101, such as the insurance company computer system 102 and the web server 103 may be linked to each other via a private data network. In these embodiments, the insurance company 101 and/or one or more of its components are then linked to external systems and components via a public network such as the Internet or a PSTN. For example, when remote computer systems 106, 108 access a webpage served by the web server 103 on the public network 104, the web server 103 may also retrieve and/or transmit data to the insurance company computer system 102 via the private data network. In other embodiments, the web server 103 may not be part of the insurance company 101. Instead, the web server 103 may be operated by third parties.

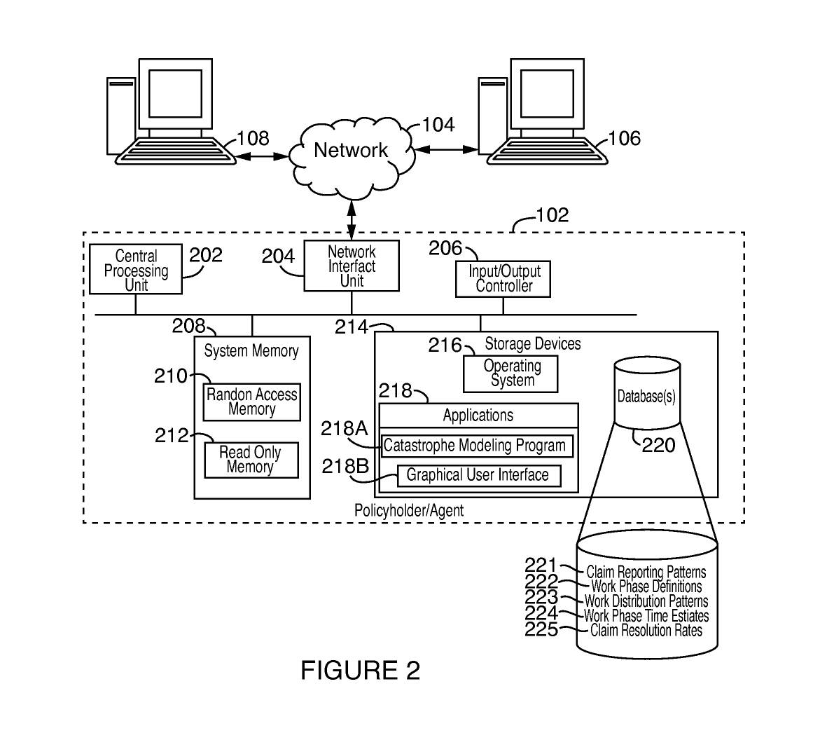

FIG. 2 is a block diagram of an insurance company computer system 102 in the insurance computer network 100 of FIG. 1, according to an illustrative embodiment of the invention. Insurance company computer system 102 comprises at least one central processing unit (CPU) 202, system memory 208, which includes at least one random access memory (RAM) 210 and at least one read-only memory (ROM) 212, at least one network interface unit 204, an input/output controller 206, and one or more data storage devices 214. All of these latter elements are in communication with the CPU 202 to facilitate the operation of the insurance company computer system 102. Suitable computer program code may be provided for executing numerous functions. For example, the computer program code may include program elements such as an operating system, a database management system and “device drivers” that allow the processor to interface with computer peripheral devices (e.g., a video display, a keyboard, a computer mouse, etc.) via the input/output controller 206.

The insurance company computer system 102 may be configured in many different ways. In the embodiment shown in FIG. 2, the insurance company computer system 102 is linked, via network 104 (also described in FIG. 1), to one or more remote computer systems 106, 108. Insurance company computer system 102 may be a conventional standalone computer or alternatively, the function of computer system 102 may be distributed across multiple computing systems and architectures. In some embodiments, insurance company computer system 102 may be configured in a distributed architecture, wherein databases and processors are housed in separate units or locations. Some such units perform primary processing functions and contain at a minimum, a general controller or a processor 202 and a system memory 208. In such an embodiment, each of these units is attached via the network interface unit 204 to a communications hub or port (not shown) that serves as a primary communication link with other servers, client or user computers and other related devices. The communications hub or port may have minimal processing capability itself, serving primarily as a communications router. A variety of communications protocols may be part of the system, including but not limited to: Ethernet, SAP®, SAS®, ATP, BLUETOOTH®, GSM and TCP/IP.

The CPU 202 comprises a processor, such as one or more conventional microprocessors and one or more supplementary co-processors such as math co-processors. The CPU 202 is in communication with the network interface unit 204 and the input/output controller 206, through which the CPU 202 communicates with other devices such as other servers, user terminals, or devices. The network interface unit 204 and/or the input/output controller 206 may include multiple communication channels for simultaneous communication with, for example, other processors, servers or client terminals. Devices in communication with each other need not be continually transmitting to each other. On the contrary, such devices need only transmit to each other as necessary, may actually refrain from exchanging data most of the time, and may require several steps to be performed to establish a communication link between the devices.

The CPU 202 is also in communication with the data storage device 214. The data storage device 214 may comprise an appropriate combination of magnetic, optical and/or semiconductor memory, and may include, for example, RAM, ROM, flash drive, an optical disc such as a compact disc and/or a hard disk or drive. The CPU 202 and the data storage device 214 each may be, for example, located entirely within a single computer or other computing device; or connected to each other by a communication medium, such as a USB port, serial port cable, a coaxial cable, an Ethernet type cable, a telephone line, a radio frequency transceiver or other similar wireless or wired medium or combination of the foregoing. For example, the CPU 202 may be connected to the data storage device 214 via the network interface unit 204.

The data storage device 214 may store, for example, (i) an operating system 216 for the insurance company computer system 102; (ii) one or more applications 218 (e.g., computer program code and/or a computer program product) adapted to direct the CPU 202 in accordance with the present invention, and particularly in accordance with the processes described in detail with regard to the CPU 202; and/or (iii) database(s) 220 adapted to store information that may be utilized by one or more applications 218. Various applications 218 may be executed by the CPU 202 of insurance company computer system 102—including a Catastrophe Resource-Modeling program 218A and Graphical User Interface application 218B.

The operating system 216 and/or applications 218 may be stored, for example, in a compressed, an uncompiled and/or an encrypted format, and may include computer program code. The instructions of the computer program code may be read into a main memory of the processor from a computer-readable medium other than the data storage device 214, such as from the ROM 212 or from the RAM 210. While execution of sequences of instructions in the program causes the processor 202 to perform the process steps described herein, hard-wired circuitry may be used in place of, or in combination with, software instructions for implementation of the processes of the present invention. Thus, embodiments of the present invention are not limited to any specific combination of hardware and software.

The term “computer-readable medium” as used herein refers to any medium that provides or participates in providing instructions to the processor of the computing device (or any other processor of a device described herein) for execution. Such a medium may take many forms, including but not limited to, non-volatile media and volatile media. Non-volatile media include, for example, optical, magnetic, or opto-magnetic disks, such as memory. Volatile media include dynamic random access memory (DRAM), which typically constitutes the main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM or EEPROM (electronically erasable programmable read-only memory), a FLASH-EEPROM, any other memory chip or cartridge, or any other medium from which a computer can read.

Various forms of computer readable media may be involved in carrying one or more sequences of one or more instructions to the processor 202 (or any other processor of a device described herein) for execution. For example, the instructions may initially be borne on a magnetic disk of a remote computer (not shown). The remote computer can load the instructions into its dynamic memory and send the instructions over an Ethernet connection, cable line, or even telephone line using a modem. A communications device local to a computing device (e.g., a server) can receive the data on the respective communications line and place the data on a system bus for the processor. The system bus carries the data to main memory, from which the processor retrieves and executes the instructions. The instructions received by main memory may optionally be stored in memory either before or after execution by the processor. In addition, instructions may be received via a communication port as electrical, electromagnetic or optical signals, which are exemplary forms of wireless communications or data streams that carry various types of information.

An application 218 may also be implemented in programmable hardware devices such as field programmable gate arrays, programmable array logic, programmable logic devices or the like. Applications 218 may also be implemented in software for execution by various types of computer processors. An application 218 of executable code may, for instance, comprise one or more physical or logical blocks of computer instructions, which may, for instance, be organized as an object, procedure, process or function. Nevertheless, the executables of an identified application 218 need not be physically located together, but may comprise separate instructions stored in different locations which, when joined logically together, comprise the application 218 and achieve the stated purpose for the application 218 such as implementing the logic prescribed by system 102. In the present invention an application 218 of executable code may be a compilation of many instructions, and may even be distributed over several different code partitions or segments, among different programs, and across several devices.

Data stored in database(s) 220 may be identified and illustrated herein within one or more applications 218, and may be embodied in any suitable form and organized within any suitable type of data structure. Such data may be collected as a single data set, or may be distributed over different locations including over different storage devices, and may exist, at least partially, merely as electronic signals on a system and/or network as shown and describe herein. Database(s) 220 may include a database management system (DBMS) software of a relational database type, such as a DB2 UNIVERSAL DATABASE™ provided by International Business Machines Corporation, an Access™ product provided by Microsoft Corporation or an Oracle® Database product provided by Oracle Corporation for storing and processing information related to workers compensation related complaint information in the present invention. In some embodiments, database(s) 220 may also provide certain database query functions such as generation of structured query language (SQL) in real time to access and manipulate the data.

Catastrophe Resource-Modeling program 218A and Graphical User Interface application 218B may be executed by CPU 202 of insurance company computer system 102 to implement the processes for determining the number of persons necessary to process a projected number of insurance claims for a forecasted catastrophic event. The Catastrophe Resource-Modeling program 218A comprises resource-modeling rules for determining the number of persons necessary to process a projected number of insurance claims based on a set of variables. Graphical user interface application 218B may be executed by CPU 202 to generate a graphical user interface for receiving inputs for certain variables for executing Catastrophe Resource-Modeling program 218A. In one embodiment, Catastrophe Resource-Modeling program 218A and Graphical User Interface application 218B may be implemented in a spreadsheet program. It should be appreciated that in the embodiments described herein, the spreadsheet program may include the Numbers program from Apple, Lotus 1-2-3 program from IBM and the EXCEL program from Microsoft as well as other relational databases systems and programs as known in the art.

In one embodiment, the projected number or claims may be a user input into the Catastrophe Resource-Modeling program 218A. In another embodiment, Catastrophe Resource-Modeling program 218A executed by CPU 202 may calculate the projected number of insurance claims expected to result from a forecasted catastrophic event. The projected number of insurance claims may be calculated based on the type of catastrophic event, the severity of the catastrophic event, the region to be affected by the catastrophic event, and the insurance company's exposure in the region to be affected by the catastrophic event. Based on the type and severity of a forecasted catastrophic event, Catastrophe Resource-Modeling program 218A can identify the different types of insurance claims that can be expected. Based on the types of insurance claims that are expected from the catastrophic event, the region that is expected to be affected, and the insurance company's exposure (i.e., number of policyholders in the region who are insured for the types of claims that are expected from the catastrophic event), Catastrophe Resource-Modeling program 218A can calculate the projected number of claims. It should be understood that the projected number of claims may be a number range or a specific number.

Database(s) 220 may store data such as predefined insurance claim-reporting patterns 221, definitions for a series of work phases for processing insurance claims 222, work distribution patterns for each of the work phases 223, time estimates for completing each of the work phases 224, and claim resolution rates for each of the work phases 225.

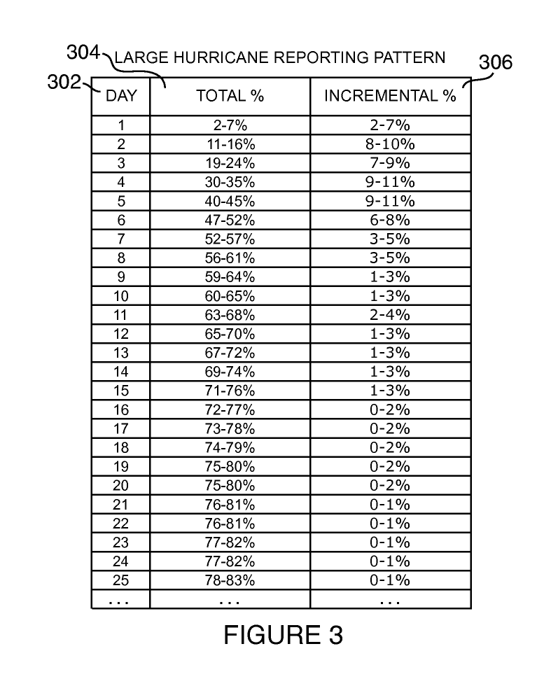

Claim reporting patterns 221 define the percentage of total projected insurance claims for a catastrophic event that are expected to be reported on a daily basis for the duration of the catastrophic event (i.e., the period of time for all insurance claims to be reported). For example, FIG. 3 shows a chart illustrating an exemplary claim-reporting pattern 221 for a large hurricane type catastrophic event. In the exemplary chart of FIG. 3, column 302 shows the days of the catastrophic event, column 304 shows the percentage of total projected claims (i.e., total reported claims) and column 306 shows the incremental percentage of claims (i.e., newly reported claims) that are expected to be reported by day. For instance, for a large hurricane type catastrophic event, 2-7% of the total projected claims are expected to be reported by day 1 of the catastrophic event. For day 10 of a large hurricane type catastrophic event, FIG. 3 shows that 60-65% of the total projected claims are expected to be reported and 1-3% of the total projected claims are expected to be newly reported claims. For day 20 of a large hurricane type catastrophic event, FIG. 3 shows that 75-80% of the total projected claims is expected to be reported and 0-2% of the total projected claims are expected to be newly reported claims. The exemplary claim-reporting pattern of FIG. 3 represents the historical averages of percentages of total claims reported by day for multiple past large hurricane type catastrophic events.

Claim reporting patterns 221 may be established based on historical data of past catastrophic events. For example, claim-reporting patterns 221 may be established based on observed insurance claim reporting for different types of catastrophic events and different regions of the country. Accordingly, claim-reporting patterns may be stored for different types of catastrophic events (e.g., hurricanes, hailstorms) and more specifically for different types of catastrophic events in different regions of the country (e.g., Southwest hurricanes, Midwest hailstorms). A greater degree of specificity in establishing the claim-reporting patterns may be advantageous, because people may respond differently to different types of catastrophic events and people in different regions of the country may respond differently to a catastrophic event.

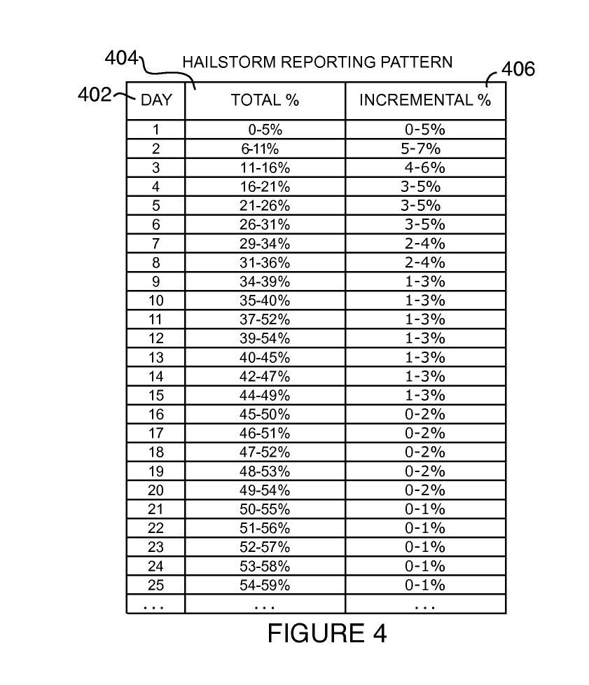

For example, FIG. 4 shows a chart illustrating an exemplary claim-reporting pattern for a hailstorm type catastrophic event, which is different than the reporting pattern for a large hurricane type catastrophic type event illustrated by the chart shown in FIG. 3. In the exemplary chart of FIG. 4, column 402 shows the days of the catastrophic event, column 404 shows the percentage of total projected claims (i.e., total reported claims) and column 406 shows the incremental percentage of claims (i.e., newly reported claims) that are expected to be reported by day. For instance, for a hailstorm type catastrophic event, 0-5% of the total projected claims are expected to be reported by day 1 of the catastrophic event. For day 10 of a hailstorm type catastrophic event, FIG. 4 shows that 35-40% of the total projected claims are expected to be reported and 1-3% of the total projected claims are expected to be newly reported claims. For day 20 of a hailstorm type catastrophic event, FIG. 4 shows that 49-54% of the total projected claims is expected to be reported and 0-2% of the total projected claims are expected to be newly reported claims. The exemplary claim-reporting pattern of FIG. 4 represents the historical averages of percentages of total claims reported by day for multiple past hailstorm type catastrophic events.

As illustrated by the charts shown in FIGS. 3 and 4, the reporting pattern for a large hurricane may be different than the reporting pattern for a hailstorm. The difference in reporting patterns may be caused by the different types of damage associated with each type of catastrophic weather event. For example, a hailstorm may cause damage that is not apparent (e.g., roof damage) without close inspection, while a hurricane may cause damage that is immediately apparent. For some large commercial buildings, hail damage may not be apparent until someone is on the building roof to service or inspect equipment, which may not happen regularly. As shown in FIGS. 3 and 4, the reporting pattern for a hailstorm may be characterized as delayed when compared to the reporting pattern for a large hurricane. For instance, 71-76% of all claims are expected to be reported by day 15 of a large hurricane, whereas 44-49% of all claims are expected to be reported by day 15 of a hailstorm.

Also, database(s) 220 may store definitions for a series of work phases 222 and work distribution patterns 223 for each of the work phases for access by Catastrophe Resource-Modeling program 218A to determine how insurance claims are to be processed. For example, as shown in Table 1 below, three work phases may be defined for handling insurance claims resulting from a large hurricane. For example, Phase-1 work may include tasks such as performing an initial call, performing coverage analysis, issuing an acknowledgement letter, issuing a denial letter and/or assigning a claim adjuster. Phase-2 work may include tasks such as performing an inspection, creating a loss estimate, making a payment, performing a final call, and/or issuing a partial denial letter. Phase-3 work may include tasks such as performing holdback work. It is customary for insurance companies to holdback some of the replacement cost of an insured item until the repair or replacement work is completed. The amount of money held back is generally calculated as the depreciation of the insured item. Thus, holdback work may include calculating the replacement cost, calculating the depreciation, and confirming that repair or replacement has been performed and the amount of the repair or replacement. The definitions of the work phases 222 may also include the relative timing of each of the work phases and the duration of each of the work phases.

In the embodiment of Table 1, because of the nature of the tasks associated with each of the work phases, phase-1 work must be done first, phase-2 work begins after phase-1 work begins, and phase-3 work does not begin until phase-2 work is complete. Also, the start date and duration of each of the work phases may be defined to comply with insurance company guidelines, obligations and/or goals. In table 1, the first column indicates the number of days after a claim is reported, the second column indicates the percentage of Phase-1 work expected to be performed on a given day, the third column indicates the percentage of Phase-2 work expected to be performed on a given day, and the fourth column indicates the percentage of Phase-3 work expected to be completed on a given day. As shown in the embodiment of Table 1, phase-1 work is expected to begin within 1 day after an insurance claim is initially reported and is expected to be completed within 3 days after the insurance claim is initially reported. Phase-2 work is expected to begin 3 days after the insurance claim is initially reported and is expected to be completed in 12 days. Phase-3 work is expected to begin 16 days after the insurance claim is initially reported and is expected to be completed in 100 days.

TABLE 1

| DAY | PHASE 1 | PHASE 2 | PHASE 3 |
|---|---|---|---|
| 1 | 33% | | |
| 2 | 33% | | |
| 3 | 33% | 2% | |
| 4 | | 4% | |
| 5 | | 4% | |
| 6 | | 10% | |
| . . . | | ″ | |
| 14 | | 10% | |
| 15 | | | |
| 16 | | | 1% |
| . . . | | | ″ |
| 115 | | | 1% |

Additionally work distribution patterns 223 may be stored in the database(s) 220 and applied to each of the work phases. For example, in the embodiment of Table 1, phase-1 work is expected to be distributed equally over the three days in which phase-1 work is expected to be completed. Thus, as illustrated in Table 1, the work distribution pattern for phase-1 work is 33%, 33%, 33%. By contrast, phase-2 work is expected to be distributed over the twelve days in which phase-2 work is expected to be completed as follows: 2%, 4%, 4%, 10%, 10% 10%, 10%, 10%, 10%, 10%, 10%, 10%. Phase-3 work is expected to be distributed equally over the 100 days in which phase-3 work is expected to be completed, such that 1% of phase-3 work is done daily. The work distribution patterns 223 may be based on historical data regarding the performance of the tasks associated with each of the work phases. Accordingly, work distribution patterns 223 may vary depending on the definitions of the work phases 222 (e.g., tasks involved) and the type of forecasted catastrophic event (e.g., large hurricane, hailstorm, etc.).

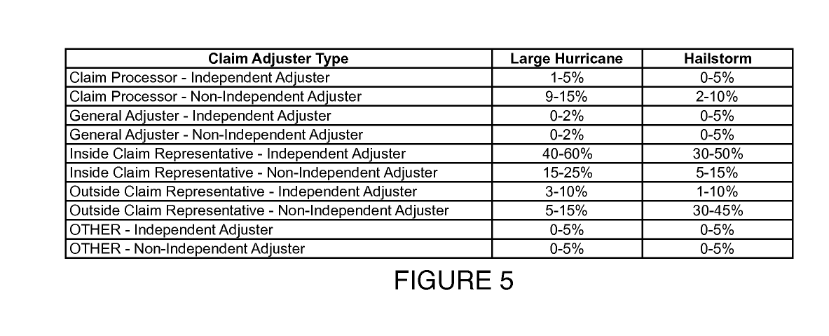

Also, database(s) 220 may store time estimates for completing each of the work phases 224 for an insurance claim for access by Catastrophe Resource-Modeling program 218A to determine the resources needed to process a projected number of claims from a forecasted catastrophic event. In one embodiment, time estimates for completing each of the work phases 224 may be based on time studies for tasks associated with each of the work phases 222 and historical data regarding the processing of claims for various types of catastrophic events. For example, time estimates for completing each of the work phases 224 may be calculated based on historical data as shown in FIG. 5. FIG. 5 lists the types of claim adjusters that perform phase-2 work, which is described in more detail above. Also, FIG. 5 shows the percentages of claims handled by each type of claim adjuster in a large hurricane type catastrophic event and in a hailstorm type catastrophic event. The percentages of claims handled by each type of claim adjuster in different types of catastrophic events may be based on historical data. The data shown in the chart of FIG. 5 represents the averages of the historical data for large hurricane type catastrophic events and hailstorm type catastrophic events.

As shown in the chart of FIG. 5, the percentage of claims handled by each type of claim adjuster may be used as a baseline by Catastrophe Resource-Modeling program 218A. However, the percentage of claims handled by each type of claim adjuster may be adjusted upward or downward based on the strain on the claims organization at any given time. The breakdown of percentages of claims handled by different claim adjusters may vary depending on factors such as region affected, severity of the catastrophic event, types of damage being seen, and number of catastrophic events directly or indirectly affecting a region (e.g., catastrophic event in recent past still occupying resources or catastrophic in nearby region occupying resources). Based on these types of factors affecting the strain on the claims organization, some claims may be shifted from one type of claim adjuster to another type of claim adjuster.

Additionally, based on time studies, it is possible to estimate how much time each type of claim adjuster spends performing phase-2 work for an insurance claim. For example, based on time studies, it was found that Outside Claim Representatives (Non-Independent Adjusters) and General Adjusters (Non-Independent Adjusters) spend an average of 140 minutes per claim for performing phase-2 work. Also, based on time studies, it was found that Independent Adjusters spend an average of 33 minutes per claim for performing phase-2 work. Additionally, based on time studies, it was found that Claim Processors (Non-Independent Adjusters) and Inside Claim Representatives (Non-Independent Adjusters) spend an average of 37 minutes per claim for performing phase-2 work.

An average time required for completing phase-2 work may be calculated based on the historical data regarding the percentages of claims handled by each type of claim adjuster in different types of catastrophic events and the time studies estimating the time spent by various types of claim adjusters. An exemplary calculation of a weighted average of the time for completing phase-2 work for a large hurricane type catastrophic event is illustrated below in Table 2. The first column of Table 2 lists the different types of claim adjusters. The second column of Table 2 shows the claim distribution among the different types of claim adjusters for a large hurricane type catastrophic event. The third column of Table 2 shows the average time spent by each type of claim adjuster performing phase-2 work. The third column shows the weighted time for each of the types of claim adjusters, which is calculated by multiplying the percentage in the second column by the time in the third column. The final row in the fourth column of Table 2 is the sum of all the rows of the fourth column and shows that the average time required to complete phase-2 work for a large hurricane type catastrophic event is 90 minutes.

TABLE 2

| | Large | | |
|---|---|---|---|
| | Hurricane | | |
| | Claim | Applicable | Weighted |
| Claim Adjuster Type | Distribution | Time | Time |
| Claim Processor - | 5% | 60 | 3 |
| Independent Adjuster | | | |
| Claim Processor - | 10% | 70 | 7 |
| Non-Independent Adjuster | | | |
| General Adjuster - | 0% | 70 | 0 |
| Independent Adjuster | | | |
| General Adjuster - | 0% | 280 | 0 |
| Non-Independent Adjuster | | | |
| Inside Claim Representative - | 50% | 70 | 35 |
| Independent Adjuster | | | |
| Inside Claim Representative - | 20% | 70 | 14 |
| Non-Independent Adjuster | | | |
| Outside Claim Representative - | 5% | 60 | 3 |
| Independent Adjuster | | | |
| Outside Claim Representative - | 10% | 280 | 28 |
| Non-Independent Adjuster | | | |
| OTHER - Independent Adjuster | 0% | 70 | 0 |
| OTHER - | 0% | 70 | 0 |
| Non-Independent Adjuster | | | |
| Total | 100% | | 90 |

Similarly, the estimated times for completing any one of the other work phases may also be calculated in accordance with the principles of the exemplary calculation described above. Also, it should be noted that a similar calculation may be carried out for another type of catastrophic event. For example, an average time for completing phase-2 work for a hailstorm type catastrophic event may be calculated by simply substituting the claim distribution percentages for a larger hurricane (as shown in column 2 of Table 2) with the claim distribution percentages for a hailstorm (as shown in the third column in FIG. 5). Accordingly, the estimated times for completing each of the work phases may be adjusted for the type of forecasted catastrophic event. Alternatively, estimated times for completing each of the work phases may be determined based on other studies, published research or any other suitable manner.

Also, database(s) 220 may store claim resolution rates 225 for each of the work phases 222. Not all of the claims initially reported and processed in phase 1 are processed in phase 2, and not all claims processed in phase 2 are processed in phase 3. Accordingly, claim resolution rates 225 may be defined for each work phase 222. For example, claim resolution rates 225 may be defined as follows: 100% of the claims reported are processed in phase 1, 90% of the claims reported are processed in phase 2, and 30% of the claims reported are processed in phase 3. In other words, the claim resolution rates 225 may be defined to reflect that 10% of the claims reported are resolved in phase 1 and 60% of the claims reported are resolved in phase 2. The claim resolution rates 225 may be averages based on historical data corresponding to the type of forecasted catastrophic event and to the same geographic region of the forecasted catastrophic event.

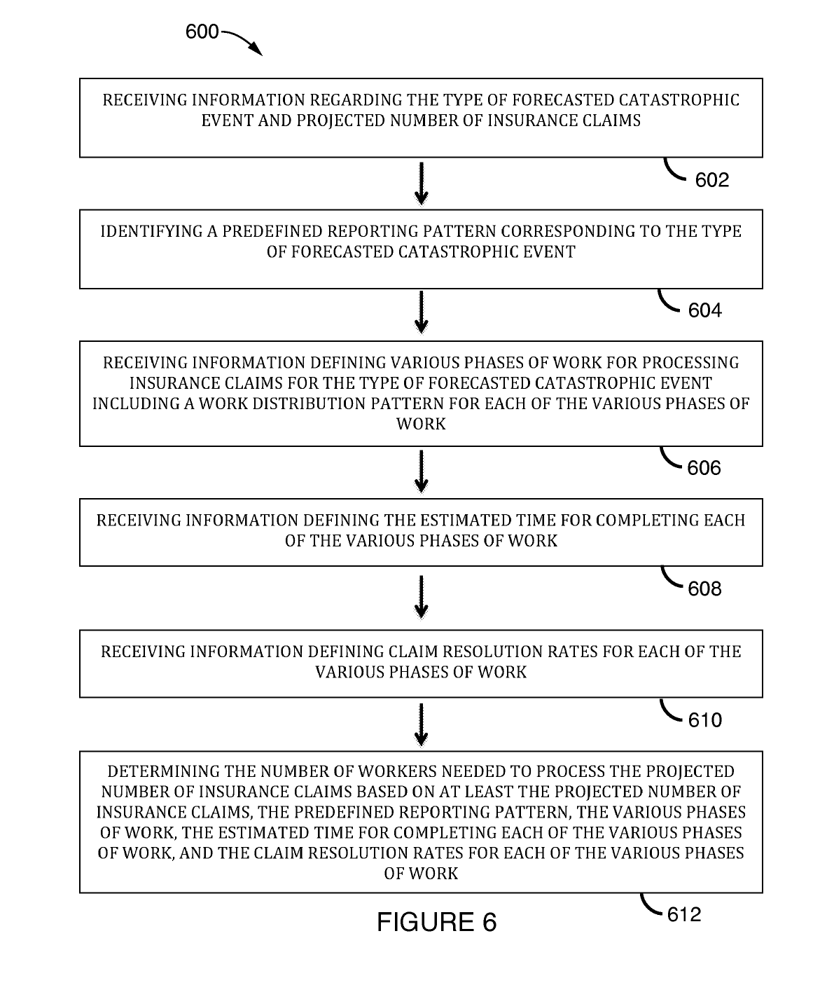

Referring to FIG. 6, the CPU 602 of insurance company computer system 102 may execute Catastrophe Resource-Modeling program 218A and Graphical User Interface application 218B to implement a computerized method 600 for determining the number of persons necessary to process a projected number of insurance claims for a forecasted catastrophic event. The Catastrophe Resource-Modeling program 218A comprises resource-modeling rules for determining the number of persons necessary to process a projected number of insurance claims based on various variables. Graphical user interface application 2188 may be executed by CPU 202 to generate a graphical user interface for receiving user inputs for defining certain variables for executing Catastrophe Resource-Modeling program 218A.

The method 600 may include a step 602 of receiving information (e.g., via a graphical user interface) regarding the type of forecasted catastrophic event and the projected number of insurance claims expected from the forecasted catastrophic event.

At a step 604, a predefined claim-reporting pattern 221 corresponding to the type of forecasted catastrophic event is identified. The predefined claim-reporting pattern 221 may be identified by a user selection of one of the plurality of claim-reporting patterns 221 stored in database(s) 220 (e.g., receiving a user selection via a graphical user interface) and/or by automatic identification of one of the stored claim-reporting patterns 221 corresponding to the type of forecasted catastrophic event identified via a user input.

At a step 606, a series of work phases 222 and work distribution patterns 223 for each of the work phases 222 are defined for determining how insurance claims are to be processed. The series of work phases 222 and work distribution patterns 223 for processing the insurance claims may be defined by user input (e.g., receiving user defined information via a graphical user interface) and/or by reference to stored data defining work phases 222 and work distribution patterns 223 for processing the insurance claims.

At a step 608, estimated times for completing each of the work phases 224 for processing insurance claims are defined. The estimated times for completing each or the work phases 224 may be defined by user input (e.g., receiving user defined information via a graphical user interface), by reference to stored data defining estimated times for completing each of the work phases 224, and/or by calculating estimated times for each of the work phases 224 in accordance with exemplary calculation described in detail above with reference to Table 2.

At a step 610, claim resolution rates 225 are defined for each of the work phases 222. The claim resolution rates 225 for each of the work phases 222 may be defined by user input (e.g., receiving user defined information via a graphical user interface) and/or by reference to stored data defining claim resolution rates 225 for each of the work phases 222.

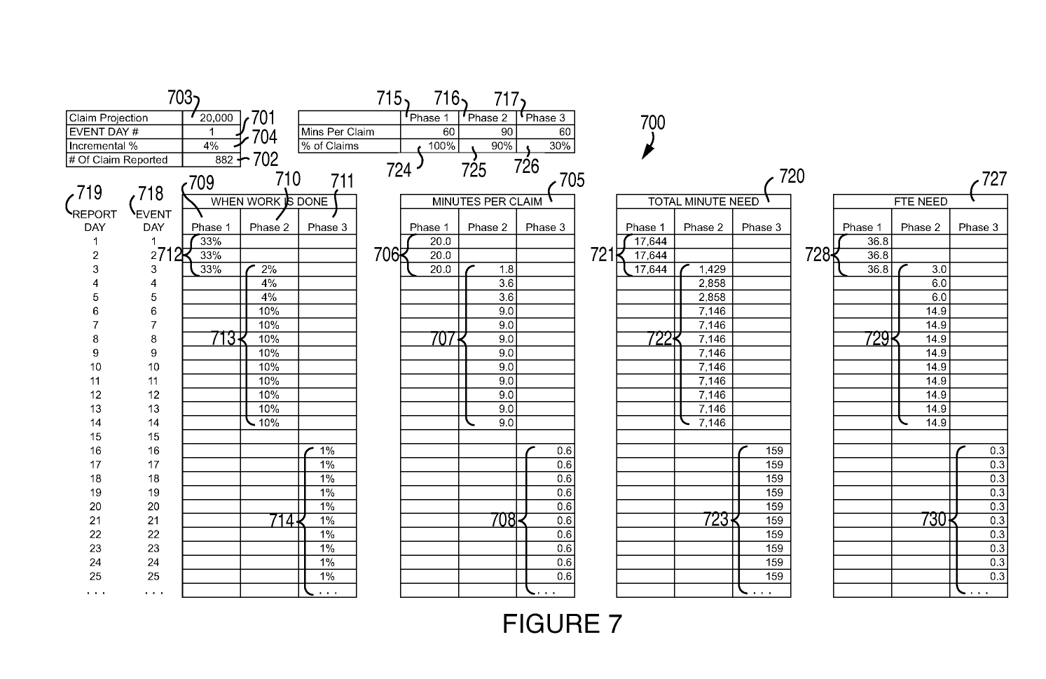

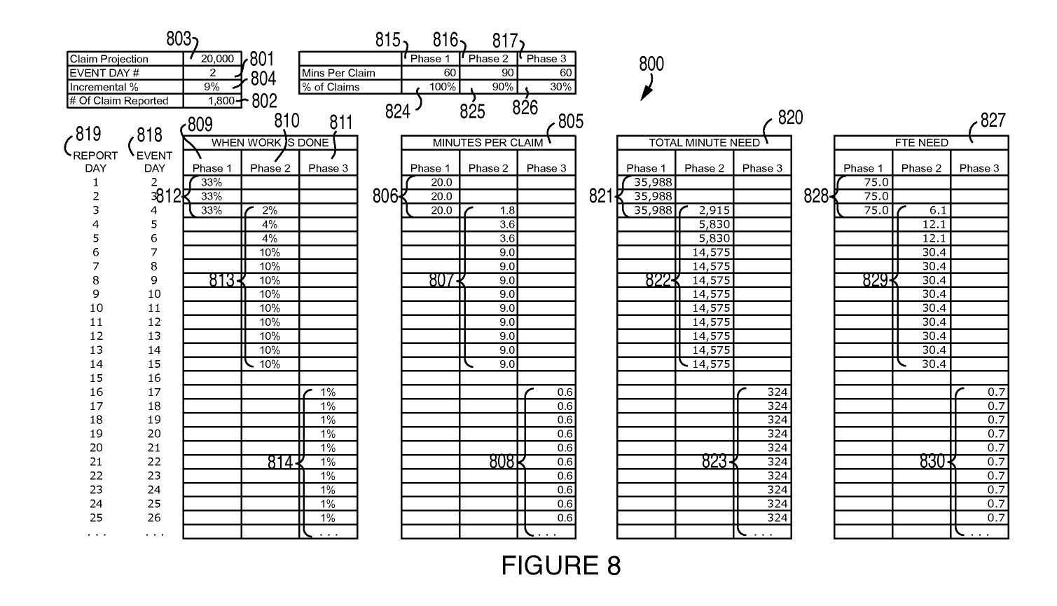

At a step 612, the number of workers needed to process the projected number of claims for the forecasted catastrophic event is determined. Step 612 may comprise a plurality of calculations as described in detail below with reference to an illustrative example shown in FIGS. 7-12. The illustrative example is based on a large hurricane type catastrophic event that is projected to generate 20,000 insurance claims. FIGS. 7 and 8 show spreadsheets 700, 800 corresponding to the calculations for new claims reported on days 1 and 2, respectively, of a large hurricane type catastrophic event. In FIGS. 7 and 8, the numbers identified by reference numerals 701, 801 indicate the day of the catastrophic event. Thus, for example, FIG. 7 corresponds to the calculations for new claims reported on day 1 of the large hurricane type catastrophic event and FIG. 8 corresponds to the calculations for new claims reported on day 2 of the large hurricane type catastrophic event. Although the calculations of step 612 are described herein with reference to days 1 and 2 of the large hurricane type catastrophic event, it is to be understood that the following descriptions apply equally to the calculations for the other remaining days of the catastrophic event.

First, the number of claims 702, 802 expected to be reported each day of the catastrophic event is determined. The number of claims 702, 802 expected to be reported each day is determined based on the projected number of insurance claims 703, 803 and a claim-reporting pattern 221 corresponding to type of forecasted catastrophic event. In this illustrative example, the claim-reporting pattern shown in FIG. 3 is used, which corresponds to large hurricane type catastrophic events. Based on the incremental reporting percentages shown for each day in the claim-reporting pattern of FIG. 3 and the projected 20,000 claims, the number of new claims 702, 802 expected to be reported each day may be determined. As shown for example in FIGS. 7 and 8, the number of new claims 602 reported per day are determined by multiplying the projected number of claims 603 (i.e., 20,000 claims) by the incremental reporting percentage 604, which is determined from the claim-reporting pattern of FIG. 3. Thus, for a large hurricane, 882 claims are expected to be reported on day 1 and 1,800 new claims are expected to be reported on day 2. Although the same number of projected claims is used and the same claim-reporting pattern is applied in the illustrations of FIGS. 7 and 8, the number of projected claims and the claim-reporting pattern applied may be changed as a catastrophic event develops and more accurate information is available.

Next, as shown in the cells of columns 705, 805 in FIGS. 7 and 8, estimated times for processing an insurance claim 706-708, 806-808 is determined for each day going forward. The time spent processing an insurance claim 706-708, 806-808 for each day going forward is determined based on the definitions for the series of work phases for processing the insurance claims 222, work distribution patterns for each of the work phases 223, and estimated times for completing each of the work phases 224. For example, there are three work phases defined in the exemplary calculations of FIGS. 7 and 8. In the illustrations of FIGS. 7 and 8, phase-1 work 709, 809 is expected to begin within 1 day after an insurance claim is initially reported and is expected to be completed within 3 days after the insurance claim is initially reported. Phase-2 work 710, 810 is expected to begin 3 days after the insurance claim is initially reported and is expected to be completed in 12 days. Phase-3 work 711, 811 is expected to begin 16 days after the insurance claim is initially reported and is expected to be completed in 100 days. Although the work phase definitions used in the illustrations of FIGS. 7 and 8 are the same, the work phase definitions may vary from day to day.

Additionally work distribution patterns 712-714, 812-814 may be applied to each of the work phases 709-711, 809-811. For example, in the embodiments of FIGS. 7 and 8, phase-1 work 709, 809 is expected to be distributed equally over the three days in which phase-1 work is expected to be completed. Thus, as illustrated in FIGS. 7 and 8, the work distribution pattern 712, 812 for phase-1 work 709, 809 is 33%, 33%, 33%. Phase-2 work 710, 810 is expected to be distributed over the twelve days in which phase-2 work is expected to be completed. As illustrated in FIGS. 7 and 8, the work distribution pattern 713, 813 for phase-2 work 710, 810 is as follows: 2%, 4%, 4%, 10%, 10% 10%, 10%, 10%, 10%, 10%, 10%, 10%. Phase-3 work 711, 811 is expected to be distributed equally over the 100 days in which phase-3 work is expected to be completed, such that work distribution pattern 714, 814 is 1% daily for 100 days. Although the work distribution patterns 712-714, 812-814 used in the various illustrations of FIGS. 7 and 8 are the same, the work distribution patterns 712-714, 812-814 may vary from day to day.

The estimated time for processing an insurance claim 706-708, 806-808 each day going forward is determined by identifying a work phase 709-7011, 809-811 for a particular day, the corresponding work distribution percentage 712-714, 812-814 for the work phase and the estimated time 715-717, 815-817 for completing the work phase. Then, the work distribution percentage 712-714, 812-814 for the work phase corresponding to that particular day is multiplied by the estimated time 715-717, 815-817 for completing the work phase. For example, as shown in FIG. 7 for day 3, time is spent doing phase 1 and phase-2 work. On day 3, 33% of the phase-1 work is expected to be done and 2% of the phase-2 work is expected to be done. Additionally, estimated times 715-717 are defined for each work phase. Phase-1 work is estimated to be completed in 60 minutes. Phase-2 work is estimated to be completed in 90 minutes. Phase-3 work is estimated to be completed in 60 minutes. Accordingly, the time spent doing phase-1 work on day 3 may be calculated by multiplying 33% by 60 minutes, which equals 20 minutes. Similarly, the time spent doing phase-2 work on day 3 may be calculated by multiplying 2% by 90 minutes, which equals 1.8 minutes. The same calculation can be carried out for the remaining days of the catastrophic event to determine an estimated amount of time 706-708 spent per claim on a particular work phase for a particular day. Although the estimated times 715-717, 815-817 for completing a work phase used in the illustrations of FIGS. 7 and 8 are the same, the estimated times 715-717, 815-817 may vary from day to day to reflect, for example, gains in efficiency.

The box of columns 705 in FIG. 7 shows the estimated time 706-708 each day going forward for processing an insurance claim that is reported on day 1. The box of columns 805 in FIG. 8 shows the estimated time 806-808 each day going forward for processing an insurance claim that is reported on day 2. It should be noted that there are two columns 718-719, 818-819 identifying days in FIGS. 7 and 8. Columns 718, 818 identify the days from the time that the catastrophic event begins. Columns 719, 819 identify the days from the time that a claim is reported. Accordingly, for a claim that is reported on day 1 of the catastrophic event as shown in FIG. 7, phase-1 work begins on day 1 of the catastrophic event, phase-2 work begins on day 3 of the catastrophic event and phase-3 work begins on day 16 of the catastrophic event. For a claim that is reported on day 2 of the catastrophic event as shown in FIG. 8, phase-1 work begins on day 2 of the catastrophic event, phase-2 work begins on day 4 of the catastrophic event and phase-3 work begins on day 17 of the catastrophic event.

Additionally, as shown in the cells of columns 720, 820 in FIGS. 7 and 8, the total estimated time 721-723, 821-823 each day going forward for processing all of the insurance claims reported on a given day is determined by identifying the estimated time 706-708, 806-808 spent per claim for a particular work phase on a particular day and identifying the percentage of claims 724-726, 824-826 that are processed for the particular work phase 709-711, 809-811 corresponding to the particular day. Then, the estimated time 706-708, 806-808 spent per claim for a particular work phase on a particular day is multiplied by the percentage of claims 724-726, 824-826 that are processed for the particular work phase corresponding to the particular day and by the number of claims reported 702, 802.

For example, as shown in FIG. 7 for day 3, time is spent doing phase 1 and phase-2 work. On day 3, 20 minutes per claim are spent on phase-1 work and 1.8 minutes per claim are spent on phase-2 work. Additionally, claim resolution rates 724-726 are defined for each work phase. In phase 1, 100% of all reported claims are processed. In phase 2, 90% of all reported claims are processed. In phase 3, 30% of all reported claims are processed. Accordingly, the total time spent doing phase-1 work on day 3 for claims reported on day 1 may be calculated by multiplying 20 minutes spent per claim by 882 claims reported on day 1 and by 100% of all reported claims being processed in phase 1 (20×882×100%), which equals 17,644 minutes. Similarly, the total time spent doing phase-2 work on day 3 for claims reported on day 1 may be calculated by multiplying 1.8 minutes spent per claim by 882 claims reported on day 1 and by 90% of all reported claims being processed in phase 2 (1.8×882×90%), which equals 1,429 minutes. The box of columns 720 in FIG. 7 shows the total estimated time 721-723 each day going forward for processing all insurance claims reported on day 1. The same calculation can be carried out for the remaining days of the catastrophic event to determine an estimated amount of time spent on a particular work phase for a particular day. For example, the box of columns 820 in FIG. 8 shows the total estimated time each day going forward for processing all insurance claims reported on day 2.

Further, the number of persons needed each day to process all the insurance claims reported on a given day may be determined based on the total estimated time each day for processing all the insurance claims reported on the given day and the number of hours a person works. Thus, in order to determine the number of persons needed to process all of the claims reported on a given day, the total estimated time each day for processing all the insurance claims reported on the given day is divided by the time a person can work. For example, as shown in FIG. 7 for day 3, time is spent doing phase 1 and phase-2 work. The total time spent doing phase-1 work on day 3 for claims reported on day 1 is 17,644 minutes. The total time spent doing phase-2 work on day 3 for claims reported on day 1 is 1,429 minutes. In the exemplary illustrations of FIGS. 7 and 8, a person is defined as a full-time employee that works 8 hours per day (or 480 minutes per day), but a person may be defined in any other suitable way. Thus, as shown in FIG. 7, in order to determine the number of persons needed on day 3 to perform phase-1 work for claims reported on day 1, 17,644 minutes are divided by 480 minutes per person, which equals 37 persons. Similarly, in order to determine the number of persons needed day 3 to perform phase-2 work for claims reported on day 1, 1,429 minutes are divided by 480 minutes per person, which equals 3 persons. Box of columns 720 in FIG. 7 shows the number of persons 728-730 needed each day going forward for processing all insurance claims reported on day 1. The same calculation can be carried out for the remaining days of the catastrophic event to determine an estimated amount of time spent on a particular work phase for a particular day. For example, box of columns 820 in FIG. 8 shows the number of persons 828-830 needed each day going forward for processing all insurance claims reported on day 2.

Although the calculations of step 612 are described herein with reference to days 1 and 2 of a large hurricane type catastrophic event, it is to be understood that the above descriptions of the calculations apply equally to the other remaining days of the catastrophic event. Accordingly, the above-described calculations may be performed for every day in the claim-reporting pattern or some subset thereof.

Based on the calculations described above, the total number of persons needed each day for processing the projected claims of the forecasted catastrophic event may be determined.

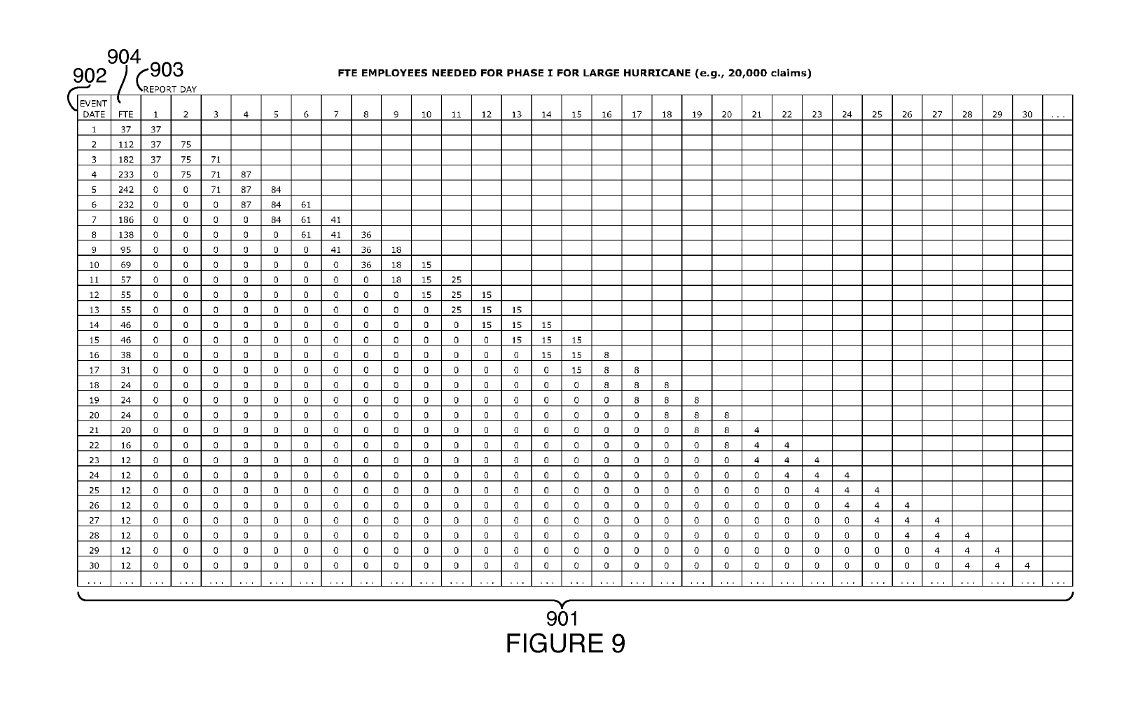

FIG. 9 is a chart that shows the number of persons 901 (e.g., full-time employees (FTEs)) needed each day 902 of a catastrophic event for performing phase-1 work for claims reported on a given day 903. The number of persons 901 (e.g., FTEs) is determined based on calculations as described above with reference to FIGS. 7 and 8 and similar calculations for the other days of the forecasted large hurricane type catastrophic event. In FIG. 9, the first column identifies the days 902 from the time that the catastrophic event begins, the second column identifies the total number of persons 904 (e.g., FTEs) needed on a given day 902 for performing phase-1 work, and the first row identifies the day 903 on which the claims were reported. Accordingly, as shown in FIG. 9 for day 4, 75 persons are needed to perform phase-1 work for claims reported on day 2 (as shown in the calculation of FIG. 8), 71 persons are needed to perform phase-1 work for claims reported on day 3, 87 persons are needed to perform phase-1 work for claims reported on day 4, and 233 total persons (75+71+87) are needed for performing phase-1 work on day 4 of the catastrophic event.

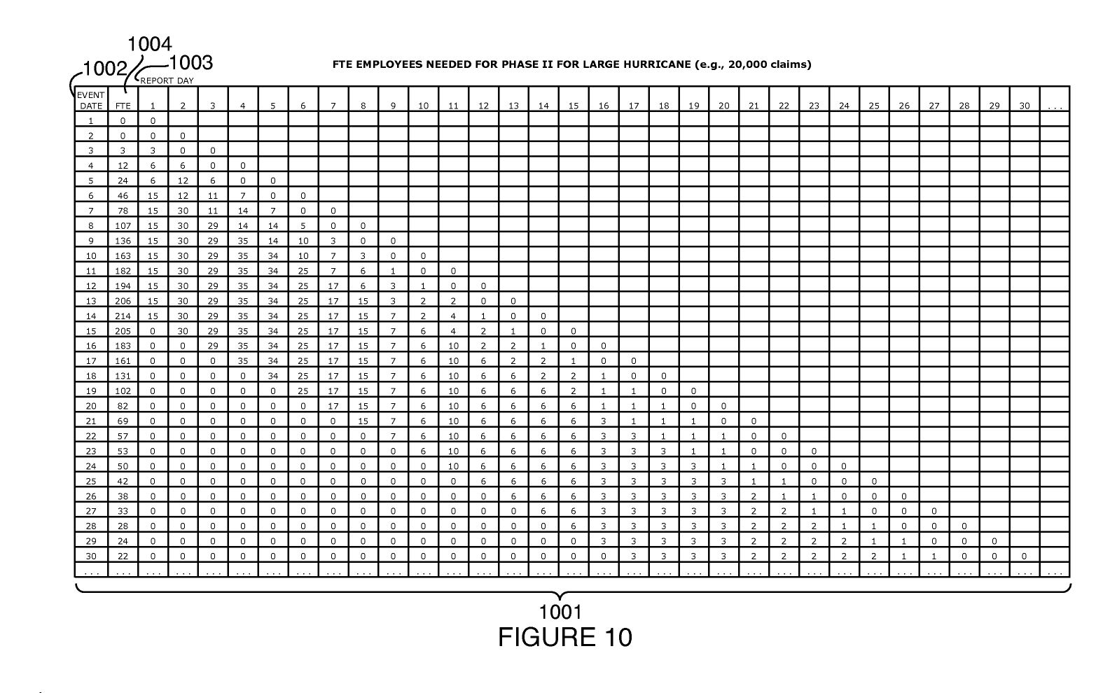

FIG. 10 is a chart that shows the number of persons 1001 needed each day 1002 for performing phase-2 work for claims reported on a given day 1003. The number of persons 1001 (e.g., FTEs) is determined based on calculations as described above with reference to FIGS. 7 and 8 and similar calculations for the other days of the forecasted large hurricane type catastrophic event. In FIG. 10, the first column identifies the days 1002 from the time that the catastrophic event begins, the second column identifies the total number of persons 1004 needed on a given day 1002 for performing phase-2 work, and the first row identifies the day 1003 on which the claims were reported. Accordingly, as shown in FIG. 10 for day 5, 6 persons are needed to perform phase-2 work for claims reported on day 1 (as shown in the calculation of FIG. 7), 12 persons are needed to perform phase-2 work for claims reported on day 2 (as shown in the calculations of FIG. 8), 6 persons are needed to perform phase-2 work for claims reported on day 3, and 24 total persons (6+12+6) are needed for performing phase-2 work on day 5 of the catastrophic event.

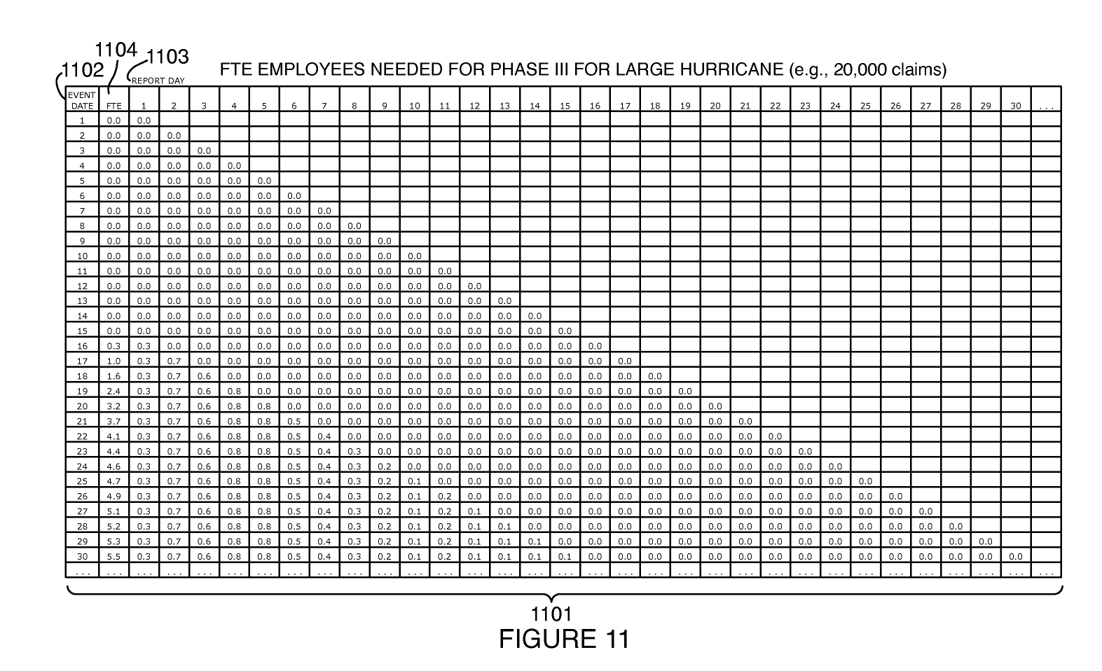

FIG. 11 is a chart that shows the number of persons 1101 needed each day 1102 for performing phase-3 work for claims reported on a given day 1103. The number of persons 1101 (e.g., FTEs) is determined based on calculations as described above with reference to FIGS. 7 and 8 and similar calculations for the other days of the forecasted large hurricane type catastrophic event. In FIG. 11, the first column identifies the days 1102 from the time that the catastrophic event begins, the second column identifies the total number of persons 1104 needed on a given day 1102 for performing phase-3 work, and the first row identifies the day 1103 on which the claims were reported. Accordingly, as shown in FIG. 11 for day 18, 0.3 persons are needed to perform phase-3 work for claims reported on day 1 (as shown in the calculation of FIG. 7), 0.7 persons are needed to perform phase-3 work for claims reported on day 2 (as shown in the calculations of FIG. 8), 0.6 persons are needed to perform phase-3 work for claims reported on day 3, and 2 total persons (0.3+0.7+0.6) are needed for performing phase-3 work on day 18 of the catastrophic event.

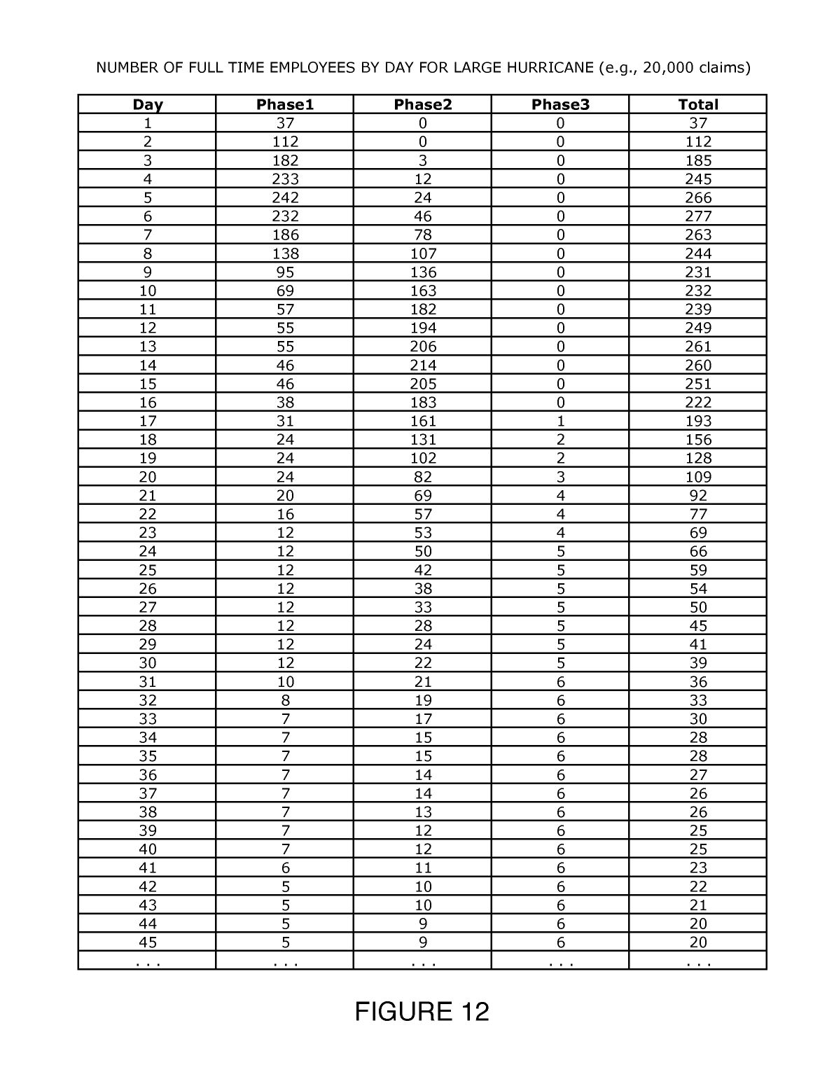

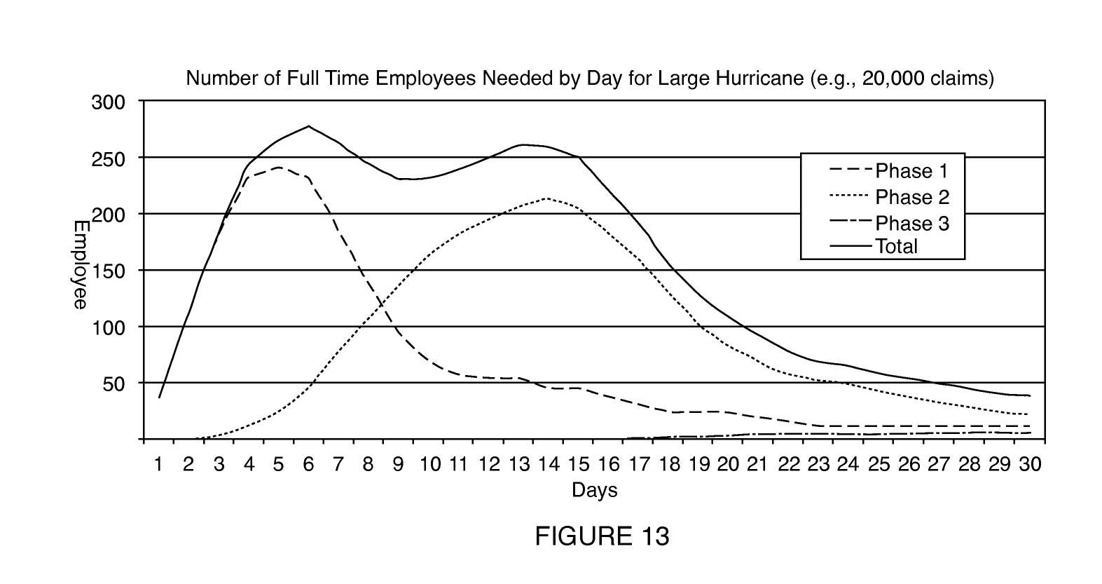

FIG. 12 is a summary chart of the information shown in FIGS. 9-11. FIG. 12 shows the number of persons (e.g., FTEs) needed to perform phase-1 work, phase-2 work and phase-3 work each day and the total number of persons needed each day. FIG. 13 is a graphical illustration of the information in FIG. 12. As shown in FIGS. 12 and 13, for a large hurricane type catastrophic event with 20,000 projected claims, the number of persons (e.g., FTEs) needed to perform phase-1 work peaks at 242 persons (e.g., FTEs) on day 5. The number of persons (e.g., FTEs) needed to perform phase-1 work increases relatively quickly within the first five days of a large hurricane type catastrophic event, decreases almost as quickly in the subsequent five days, and tapers off gradually thereafter. A large percentage of the phase-1 work is performed in the first 10 days of a large hurricane type catastrophic event. Also as shown in FIGS. 12 and 13, for a large hurricane type catastrophic event with 20,000 projected claims, the number of persons (e.g., FTEs) needed to perform phase-2 work peaks at 214 persons (e.g., FTEs) on day 14. A large percentage of the phase-2 work is performed between days 7 and 20 of a large hurricane type catastrophic event. Further, as shown in FIGS. 12 and 13, for a large hurricane type catastrophic event with 20,000 projected claims, the number of persons (e.g., FTEs) needed to perform phase-3 does not surpass 6 persons (e.g., FTEs) and is fairly consistent. Lastly, as shown in FIGS. 12 and 13 the total number of persons (e.g., FTEs) needed to perform all work phases has a double peak at days 6 and 13. The total number of persons (e.g., FTEs) needed to perform all work phases increases rapidly in the first six days of a large hurricane type catastrophic event, dips briefly over the subsequent four days, increases again over the next four days, and decreases considerably in the period thereafter. When considering work for three work phases together, a larger percentage of the work is performed in the first 20 days of a large hurricane type catastrophic event.

Although this invention has been shown and described with respect to detailed embodiments thereof, it will be understood by those skilled in the art that various changes in form and detail thereof may be made without departing from the spirit and the scope of the invention. With respect to the embodiments of the systems described herein, it will be understood by those skilled in the art that one or more system components may be added, omitted or modified without departing from the spirit and the scope of the invention. With respect to the embodiments of the methods described herein, it will be understood by those skilled in the art that one or more steps may be omitted, modified or performed in a different order and that additional steps may be added without departing from the spirit and the scope of the invention. Further, computerized method 300 is described herein with reference to specific exemplary calculations illustrated in FIGS. 6-14. It should be understood, however, that the exemplary calculations of FIGS. 6-14 are referenced only to illustrate the underlying logic for the systems and methods described herein and are not to be interpreted to limit the present inventions.

What is claimed is:

1. A computer system for determining a number of persons necessary to process a projected number of insurance claims expected from a forecasted catastrophic event, comprising:
a data storage device comprising a database and a resource-modeling program for determining the number of persons necessary to process the projected number of insurance claims expected from the forecasted catastrophic event;
the database storing one or more reporting patterns corresponding to a plurality of catastrophic events and time estimates for processing insurance claims for various types of catastrophic events;
at least one processor connected to the data storage device for executing the resource-modeling program to:
store information regarding the projected number of insurance claims expected from the forecasted catastrophic event;
store a selection of a reporting pattern corresponding to the type of forecasted catastrophic event from the one or more reporting patterns stored in the database; and
determine the number of persons per day necessary to process the projected number of insurance claims, based on at least the projected number of insurance claims, the selected reporting pattern, and one of the time estimates corresponding to the forecasted catastrophic event.

2. The system according to claim 1, the data storage device further comprising a graphical user interface application, which is executed by the at least one processor to generate a graphical user interface to receive information regarding the projected number of insurance claims and the selection of a reporting pattern.

3. The system according to claim 1, wherein the at least one processor further executes the resource-modeling program to transmit, to a remote computer system in communication with the at least one processor, the determined number of persons per day necessary to process the projected number of insurance claims.

4. The system according to claim 1, wherein at least one of the time estimates for processing insurance claims for various types of catastrophic events is calculated based on how insurance claims for the type of forecasted catastrophic event have been historically resolved.

5. The system according to claim 1, wherein each of the one or more reporting patterns defines, based on historical data, the percentage of a total number of reported claims that have been historically reported per day for a particular type of catastrophic event.

6. The system according to claim 1, wherein the claim reporting pattern varies by geographic region.

7. The system according to claim 1, wherein the at least one processor further executes the resource-modeling program to:
define at least two work phases for processing insurance claims;
define a work distribution pattern to apply to each of the work phases, the work distribution pattern defining the number of days for completing a work phase and a percentage of a work phase to be completed each day;
and
determine the number of persons per day necessary to process the projected number of insurance claims, based on at least the projected number of insurance claims, the selected reporting pattern, the defined series of work phases, and the defined work distribution patterns.

8. The system according to claim 7, wherein the at least one processor further executes the resource-modeling program to:
determine time estimates for completing each of the work phases in accordance with the applied work distribution pattern; and
determine the number of persons per day necessary to process the projected number of insurance claims, based on at least the projected number of insurance claims, the selected reporting pattern, the defined series of work phases, the defined work distribution patterns, and the determined estimated time for completing each of the work phases.

9. The system according to claim 8, wherein the at least one processor further executes the resource-modeling program to:
apply a claim resolution rate for each of the work phases; and
determine the number of persons per day necessary to process the projected number of insurance claims, based on at least the projected number of insurance claims, the selected reporting pattern, the defined series of work phases, the defined work distribution patterns, the determined estimated time for completing each of the work phases, and the defined claim resolution rates for each of the work phases.

10. A computerized method for determining a number of persons necessary to process a projected number of insurance claims from a forecasted catastrophic event, comprising:
accessing, by a resource-modeling program executed by a computer processor, information regarding the projected number of insurance claims expected from the forecasted catastrophic event;
accessing, by the resource-modeling program executed by the computer processor, a selection of a reporting pattern corresponding to the type of forecasted catastrophic event from the one or more reporting patterns stored in the database;
determining a time estimate for processing an insurance claim for the forecasted catastrophic event;
determining, by the resource-modeling program executed by the computer processor, the number of persons per day necessary to process the projected number of insurance claims, based on at least the projected number of insurance claims, the selected reporting pattern, and the determined time estimate for processing an insurance claim for the forecasted catastrophic event.

11. The method according to claim 10, wherein the information regarding the projected number of insurance claims and the selection of a reporting pattern are received via a graphical user interface generated by a graphical user interface application executed on the computer processor.

12. The method according to claim 10, further comprising a step of transmitting, by the resource-modeling program executed by the computer processor to a remote computer system in communication with the computer processor, the determined number of persons per day necessary to process the projected number of insurance claims.

13. The method according to claim 10, wherein the projected number of insurance claims is based on historical claim data for past catastrophic events and on current insurance company exposure.

14. The method according to claim 10, wherein the reporting pattern defines percentages of the projected number of insurance claims that are expected to be reported on different days based on historical data of past catastrophic events.

15. The method according to claim 10, wherein the determined estimated time for completing each of the work phases is variable over time to reflect efficiency gains.

16. The method according to claim 10, wherein the determined estimated time for completing each of the work phases is dependent on the type of forecasted catastrophic event.

17. The method according to claim 10, wherein the claim reporting pattern varies by geographic region.

18. The method according to claim 10, further comprising:
defining, by the resource-modeling program executed by the computer processor, two or more work phases for processing insurance claims;
defining, by the resource-modeling program executed by the computer processor, a work distribution pattern to apply to each of the work phases, the work distribution pattern defining the number of days for completing a work phase and a percentage of a work phase to be completed per day;
and
determining, by the computer processor, the number of persons per day necessary to process the projected number of insurance claims, based on at least the projected number of insurance claims, the selected reporting pattern, the defined series of work phases, and the defined work distribution patterns.

19. The method according to claim 18, further comprising:
determining, by the resource-modeling program executed by the computer processor, an estimated time for completing each of the work phases in accordance with the applied work distribution pattern; and
determining, by the computer processor, the number of persons per day necessary to process the projected number of insurance claims, based on at least the projected number of insurance claims, the selected reporting pattern, the defined series of work phases, the defined work distribution patterns, and the time estimates for completing each of the work phases.

20. The method according to claim 10, further comprising:
applying, by the resource-modeling program executed by the computer processor, a claim resolution rate for each of the work phases; and
determining, by the computer processor, the number of persons per day necessary to process the projected number of insurance claims, based on at least the projected number of insurance claims, the selected reporting pattern, the defined series of work phases, the defined work distribution patterns, the time estimates for completing each of the work phases, and the defined claim resolution rates for each of the work phases.

21. A non-transitory, tangible computer-readable medium storing instructions adapted to be executed by a computer processor to perform a method for determining a number of persons necessary to process a projected number of insurance claims from a forecasted catastrophic event, the method comprising the steps of:
accessing, by a resource-modeling program executed by a computer processor, information regarding the projected number of insurance claims expected from the forecasted catastrophic event;
accessing, by the resource-modeling program executed by the computer processor, a selection of a reporting pattern corresponding to the type of forecasted catastrophic event from the one or more reporting patterns stored in the database;
determining a time estimate for processing an insurance claim for the forecasted catastrophic event;
determining, by the resource-modeling program executed by the computer processor, the number of persons per day necessary to process the projected number of insurance claims, based on at least the projected number of insurance claims, the selected reporting pattern, and the determined time estimate for processing an insurance claim for the forecasted catastrophic event.

22. The non-transitory, tangible computer-readable medium of claim 21, wherein the information regarding the projected number of insurance claims and the selection of a reporting pattern are received via a graphical user interface generated by a graphical user interface application executed on the computer processor.

23. The non-transitory, tangible computer-readable medium of claim 21, wherein the method further comprises a step of transmitting, via a graphical user interface generated by a graphical user interface application executed on the computer processor, the determined number of persons per day necessary to process the projected number of insurance claims.

24. The non-transitory, tangible computer-readable medium of claim 21, wherein the projected number of insurance claims is based on historical claim data for past catastrophic events and on current insurance company exposure.

25. The non-transitory, tangible computer-readable medium of claim 21, wherein the reporting pattern defines percentages of the projected number of insurance claims that are expected to be reported on different days based on historical data of past catastrophic events.

26. The non-transitory, tangible computer-readable medium of claim 21, wherein the determined estimated time for completing each of the work phases is variable over time to reflect efficiency gains.

27. The non-transitory, tangible computer-readable medium of claim 21, wherein the determined estimated time for completing each of the work phases is dependent on the type of forecasted catastrophic event.

28. The non-transitory, tangible computer-readable medium of claim 21, wherein the claim reporting pattern varies by geographic region.

29. The non-transitory, tangible computer-readable medium of claim 21, wherein the method further comprises the steps of:
defining, by the resource-modeling program executed by the computer processor, a series of work phases for processing insurance claims;
defining, by the resource-modeling program executed by the computer processor, a work distribution pattern to apply to each of the work phases, the work distribution pattern defining the number of days for completing a work phase and a percentage of a work phase to be completed per day;
and
determining, by the computer processor, the number of persons per day necessary to process the projected number of insurance claims, based on at least the projected number of insurance claims, the selected reporting pattern, the defined series of work phases, and the defined work distribution patterns.

30. The non-transitory, tangible computer-readable medium of claim 29, wherein the method further comprises the steps of:
determining, by the resource-modeling program executed by the computer processor, an estimated time for completing each of the work phases in accordance with the applied work distribution pattern; and
determining, by the computer processor, the number of persons per day necessary to process the projected number of insurance claims, based on at least the projected number of insurance claims, the selected reporting pattern, the defined series of work phases, the defined work distribution patterns, and the time estimates for completing each of the work phases.

31. The non-transitory, tangible computer-readable medium of claim 30, wherein the method further comprises the steps of:
defining, by the resource-modeling program executed by the computer processor, a claim resolution rate for each of the work phases; and
determining, by the computer processor, the number of persons per day necessary to process the projected number of insurance claims, based on at least the projected number of insurance claims, the selected reporting pattern, the defined series of work phases, the defined work distribution patterns, the time estimates for completing each of the work phases, and the defined claim resolution rates for each of the work phases.
